(19) United States
(12) Patent Application Publication
(10) Pub. No.: US 2025/0214607 A1
(43) Pub. Date: Jul. 3, 2025

(54) AUTONOMOUS VEHICLE POSITION DETERMINATION BASED ON AUTONOMOUS VEHICLE STATE CHANGE

(71) Applicant: GM Cruise Holdings LLC, San Francisco, CA (US)

(72) Inventor: Thomas Holloway, Leander, TX (US)

(21) Appl. No.: 18/403,428

(22) Filed: Jan. 3, 2024

(51) Int. Cl. B60W 60/00; B60W 50/00

(52) U.S. Cl. CPC B60W 60/001; B60W 2050/006; B60W 2556/45

(57) ABSTRACT

Systems, methods, and non-transitory computer readable mediums are provided for providing autonomous vehicle (AV) state information of an AV to a data center when an AV state change occurs so that the data center may determine one or more interpolated AV states of the AV prior to the AV state change. For example, a system may obtain sensor data generated by one or more sensor systems of the AV. Additionally, the system may determine a first AV state change of the AV at a first time based on the sensor data. Moreover, the system may generate a first message including a portion of the sensor data associated with the kinematic change in response to determining the first AV state change. Further, the system may transmit the first message to the data center.

### BACKGROUND

### 1. Technical Field

The present disclosure generally relates to position or location determinations of a vehicle and, more specifically, position or location determinations of a vehicle based on state changes of the vehicle.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2 illustrates portions of an exemplary system environment, in accordance with some aspects of the disclosed technology;

FIG. 3 illustrates a flowchart of an example process for determining an AV state change of an AV, according to some aspects of the disclosed technology;

FIG. 4 illustrates an example of a deep learning neural network, according to some aspects of the disclosed technology; and

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

In some examples, autonomous vehicles (AVs) may collect large quantities of complex and diverse sets of data (or metadata) about various operational aspects of the corresponding AV. Examples of such data (or metadata) include, but are not limited to, information about location, pose, vehicle kinematics (speed, velocity, acceleration, etc.), and/or information for various sensors and systems of the AV (collectively, AV state information). AV state information, including information about the changing states of the AV (herein described as “AV state change information”), may be provided to one or more remote systems, such as a data center. The remote systems may utilize the AV state information to make determinations about how to manage vehicle operations of the AVs. Additionally, the AVs may offload the collected large quantities of complex and diverse sets of data characterizing the AV state information to the remote systems using wireless communications. In some instances, the wireless communications may not provide adequate bandwidth to reliably transfer all the collected AV state information. Additionally, it would be advantageous to reduce the amount of AV state information received at the remote systems, for example, when large numbers of AVs are in use such as when support is provided to an AV fleet. Moreover, it would also be advantageous to reduce the amount of AV state information received at the remote systems without losing the granularity that is inherently included with the larger, more complex, and diverse sets of data characterizing the AV state information.

Aspects of the disclosed technology provide solutions for intelligently providing sets of data from the AVs at a reduced amount without losing the granularity that is inherently included with the larger, more complex, and more diverse sets of data characterizing the AV state information that is provided by the autonomous vehicles. In some examples, the AVs may provide AV state information to a data center when an AV state change occurs. The data center may determine one or more interpolated AV states of the AVs prior to the AV state change or between each time an AV state change occurs. As such, the AV connectivity costs, the service side storage and/or the query burdens may be reduced, without losing the granularity inherently included with the larger, more complex, and more diverse sets of data characterizing the AV state information that are associated with AVs that provide AV state information periodically, such as every 1/10 second.

By way of example, an AV may determine that at a first time and a second time the AV state information may indicate that the state of the AV has not changed or changed drastically enough. In such an example, the AV may not provide, to the datacenter, data characterizing the AV state information of the AV during the first time and the second time. However, at a third time, the AV may determine that the AV state information indicates the state of the AV has changed or changed drastically enough, such as the AV moving from a first lane to a second late. Based on such determinations, the AV may provide, to the data center, the AV state information indicating that at the third time the state of the AV had changed (e.g., the lane change). The data center may determine, based on the AV state information, that at the third time, an AV state change occurred with the AV, as well as one or more interpolated AV states prior to the third time, such as AV state information of the AV during the first time and the second time. The amount of data transmitted to the data center from the AV is reduced without losing the granularity inherently included with the larger, more complex, and more diverse sets of data characterizing the AV state information that is associated with AVs that provide AV state information periodically, such as every 1/10 second.

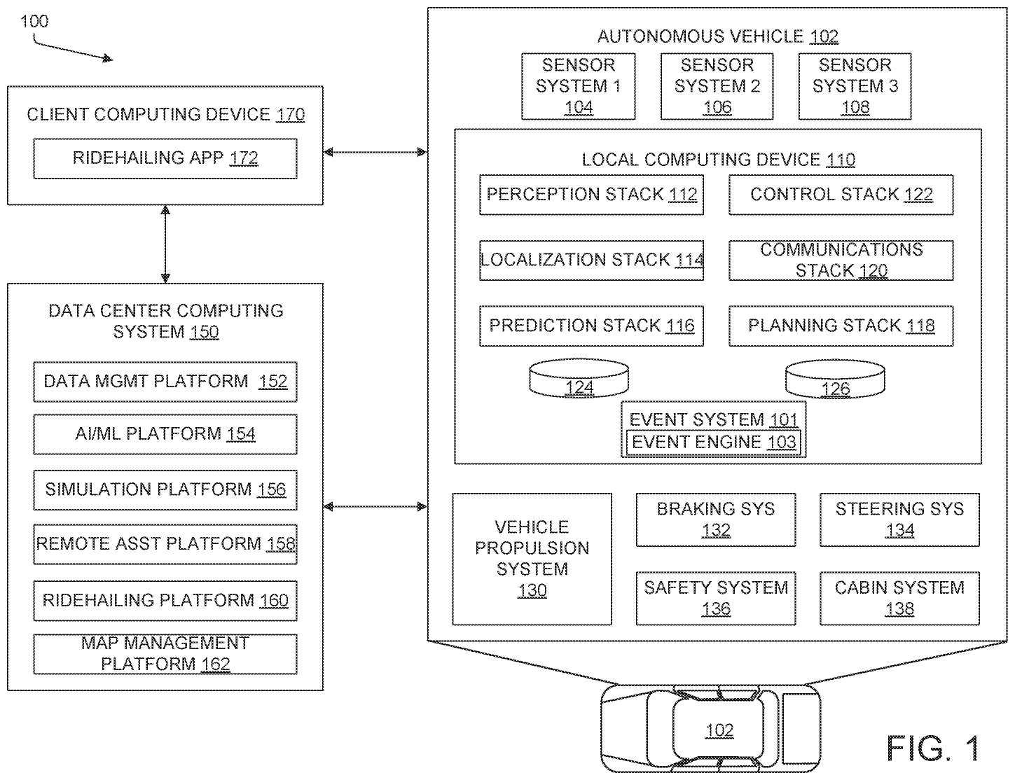

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes autonomous vehicle (AV) 102, a data center 150, and a client computing device 170. AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. Additionally, perception stack 112 may generate perception data based on the sensor data (e.g., sensor data generated from cameras, LIDAR sensors, infrared sensors, microphones, ultrasonic sensors, RADAR, pressure sensors, force sensors, impact sensors, etc.). In some examples, the perception data may be based on localization data generated by localization stack 114. As described herein, the perception data may identify and classify objects, such as road agents, around AV 102. Additionally, the perception data may include information characterizing, for each identified object, a corresponding current location, speed, direction, and the like. Moreover, the perception information may include information characterizing, for each identified object, the free space around the AV 102.

In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. Additionally, perception stack 112 may generate perception data that identifies the identified environmental uncertainties. In some examples, an output of the perception stack 112, such as the perception data, can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Additionally, localization stack 114 may generate localization data based on the sensor data (e.g., sensor data generated from GPS, IMUs, cameras, LIDAR, RADAR, ultrasonic sensors, etc.). As described herein, the localization data may indicate a location and/or pose of AV 102. Additionally, the location of AV 102 may be a current location of AV 102, while the pose of AV 102 may be the position and orientation of AV 102. In some examples, the localization data may be further based on HD map data stored in HD geospatial database 126. For example, in some cases, localization stack 114 may compare sensor data captured in real-time by one or more sensor systems, such as sensor systems 104, 106 and 108 to HD map data stored in HD geospatial database 126 to determine its precise (e.g., accurate to the order of a few centimeters or less) position and orientation.

Prediction stack 116 can receive information from the localization stack 114, such as localization data, and objects identified in perception data generated by the perception stack 112 and predict a future path for the objects. Additionally, prediction stack 116 may generate prediction data that identifies and characterizes the future path for the objects. In some examples, the prediction stack 116 may determine and generate prediction data that identifies and characterizes, for each object identified in the perception data, several likely paths that an object is predicted to take along with a probability associated with each path. For each predicted path, the prediction stack 116 may determine and generate prediction data that identifies and characterizes a range of points along the path corresponding to a predicted location of the object along the path at future time intervals along with an expected error value for each of the points that indicates a probabilistic deviation from that point.

Planning stack 118 may generate planning data based on prediction data and perception data. Additionally, planning stack can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. The planning data may include the selected set of one or more mechanical operations that AV 102 can perform. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store map data of HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs, such as AV 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the client application 172 to enable passengers to view the AV 102 in transit en route to a pick-up or drop-off location, and so on.

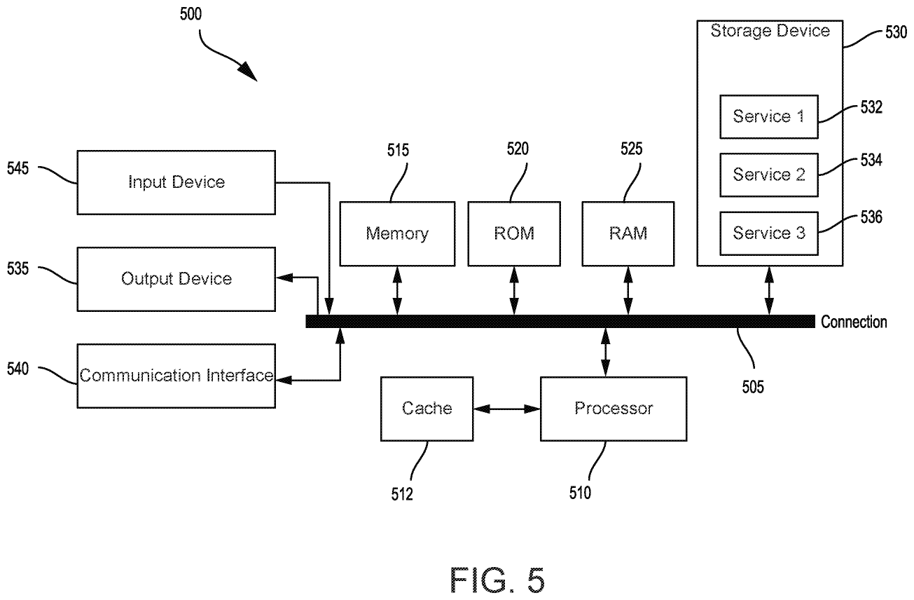

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 5.

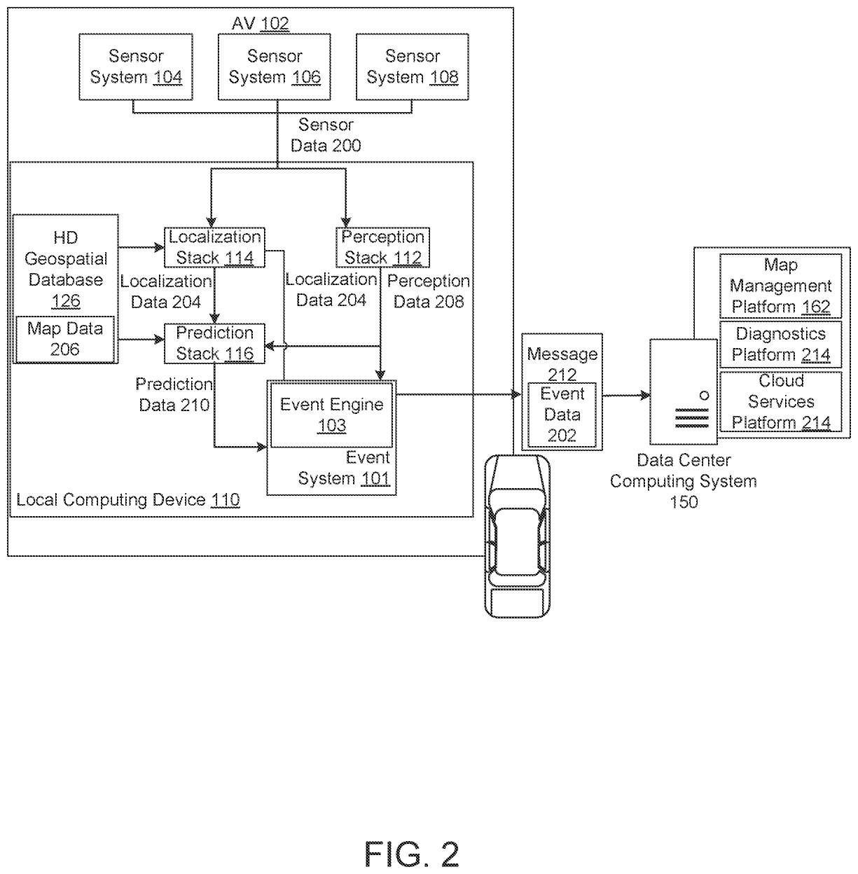

Referring to FIG. 2, at least one processor of local computing device 110 may execute event engine 103 of event system 101 to perform any of the example processes describe herein, among other things, to determine or identify one or more state changes of AV 102 (herein described as “AV state changes”). Examples of AV state changes include, kinematic changes, cabin changes, environmental changes, and emergencies. Additionally, executed event engine 103 may determine or identify the AV state changes based on data generated by one or more systems, components, modules and/or software stacks, such as sensor data 200 generated by one or more of the multiple sensor systems, such as sensor system 104, sensor system 106 and/or sensor system 108. Moreover, executed event engine 103 may generate event data 202 identifying and characterizing the AV state changes. Further, event data 202 may include a timestamp indicating the time the AV state changes were detected. As described herein, the AV state changes may cause executed event engine 103 to provide event data 202 to data center 150. Additionally, data center 150 may perform any of the example processes described herein to, among other things, implement operations that support and manage AV 102 based on the AV state changes characterized and identified in event data 202. For example, data center 150 may determine one or more interpolated AV states of AV 102 prior to the time an AV state change occurred or between AV state changes based on event data 202. Additionally, data center 150 may utilize the interpolated AV states of AV 102 to support and manage AV 102. That way, instead of data center 150 utilizing AV state information received from AV 102 periodically, such as every 1/10 second, to support and manage AV 102, data center 150 may utilize the interpolated AV states to manage and support AV 102. As such, a reduction in AV connectivity costs, service side storage and/or query burdens may be achieved without losing the granularity inherently included with the AV state information periodically received from AV 102.

In some examples, the AV state changes may be associated with a kinematic change of AV 102. Examples of a kinematic change of AV 102 includes lane changes, odometry changes (e.g., acceleration/deceleration), and pose/orientation/heading changes. In some instances, executed event engine 103 of event system 101 may obtain localization data 204 from localization stack 114 and determine AV state changes associated with a kinematic change of AV 102 based on localization data 204. As described herein, localization stack 114 may generate localization data 204 based on sensor data 200. Additionally, localization data 204 may indicate the location and/or pose of AV 102 and may indicate changes in the location and/or pose of AV 102. In such instances, localization data 204 may include a record of positions and orientations of AV 102 while AV 102 is in operation. The record may include a set of entries and each entry may indicate a position and orientation of AV 102 at a particular time represented by a timestamp also included in the entry. Moreover, executed event engine 103 may obtain map data 206 from HD geospatial database 126. Based on localization data 204 and map data 206, executed event engine 103 may compare the positions and orientations of AV 102 to determine whether AV 102 moves from one lane to another. Further, executed event engine 103 may generate event data 202 that identifies and characterizes the AV state change associated with the kinematic change—the lane change.

By way of example, the record may include a first entry and a second entry, and the second entry includes a timestamp that is after a timestamp included in the first entry. Based on a comparison between the first entry and map data 206, executed event engine 103 may determine that the position and orientation of AV 102 indicates the AV is in a first lane. Additionally, based on a comparison between the second entry and map data 206, executed event engine 103 may determine that the position and orientation of AV 102 indicates the AV is in a second lane. Based on the determinations associated with the first entry and the second entry, executed event engine 103 may determine AV 102 changed lanes between a time of timestamp of the first entry and a time of timestamp of the second entry. Executed event engine 103 may generate event data 202 that indicates the lane change. Further, event data 202 may include a timestamp indicating the time AV 102 performed the lane change. The timestamp may be based on a portion of localization data 204 that executed event engine 103 utilized to determine AV 102 performed the lane change (e.g., the portion of localization data 204 may include a timestamp for each determined location/position and/or pose of AV 102 included in the portion of localization data 204). In some instances, event data 202 may further include a lane identifier. For instance, the first entry may include a lane identifier associated with the first lane, while the second entry may include a lane identifier associated with the second lane. As described herein, certain events (e.g., the lane change or the state of AV 102 prior to the lane change) may be inferred or deduced based on AV state changes registered at different times. As such, AV 102 may avoid periodically uploading or transmitting AV state information associated with the movement of AV 102.

In other instances, executed event engine 103 may obtain sensor data 200 generated by one or more of the multiple sensor systems of AV 102 (e.g., sensor system 104, sensor system 106 and/or sensor system 108), and determine AV state changes associated with a kinematic change of AV 102 based on sensor data 200. In such instances, the AV state changes may be associated with AV 102 accelerating or decelerating. For instance, executed event engine 103 may obtain sensor data 200 generated by one or more of the multiple sensor systems of AV 102 (e.g., GPS receiver, speedometer, odometer, etc.). Additionally, sensor data 200 may be in the format of a record that includes multiple entries. Each entry may identify and characterize information generated by one or more of the multiple sensor systems of AV 102 (e.g., a corresponding value), a timestamp indicating a time the information was generated by a corresponding sensor of one of the multiple sensor systems of AV 102, and the type of sensor that generate the information. Based on the record of sensor data 200, executed event engine 103 may determine whether AV 102 accelerated and the corresponding time of the acceleration or whether AV 102 decelerated and the corresponding time of the deceleration. Further, based on such determinations, executed event engine 103 may generate event data 202 that identifies and characterizes the AV state change associated with the kinematic change—the acceleration or deceleration.

By way of example, the record may include a first entry, a second entry and a third entry. Additionally, the first entry includes a timestamp of a time prior to a time of a timestamp of the second entry and the third entry, and the time of the timestamp of the second entry is before the time of the timestamp of the third entry. Moreover, the first entry indicates AV 102 was traveling 40 miles per hour (mph), the second entry indicates AV 102 was traveling at 40 mph and the third entry indicates AV 102 is traveling at 60 mph. Based on the first entry, second entry and third entry, executed event engine 103 may determine that the AV 102 accelerated at the time of the timestamp of the third entry. Executed event engine 103 may generate event data 202 that indicates the acceleration. Further, event data 202 may include a timestamp indicating the time AV 102 accelerated. The timestamp may be based on a portion of sensor data 200 that executed event engine 103 utilized to determine AV 102 accelerated (e.g., the portion of sensor data 200 may include timestamps of when the portion of sensor data 200 was generated/captured by a corresponding sensor or sensor system).

In another example, the record may include a first entry, a second entry and a third entry. Additionally, the first entry includes a timestamp of a time prior to a time of a timestamp of the second entry and the third entry, and the time of the timestamp of the second entry is before the time of the timestamp of the third entry. Moreover, the first entry indicates AV 102 was traveling 70 mph, the second entry indicates AV 102 was traveling at 70 mph and the third entry indicates AV 102 is traveling at 30 mph. Based on the first entry, second entry and third entry, executed event engine 103 may determine that the AV 102 decelerated at the time of the timestamp of the third entry. Executed event engine 103 may generate event data 202 that indicates the deceleration. Further, event data 202 may include a timestamp indicating the time AV 102 decelerated. The timestamp may be based on a portion of sensor data 200 that executed event engine 103 utilized to determine AV 102 decelerated (e.g., the portion of sensor data 200 may include timestamps of when the portion of sensor data 200 was generated/captured by a corresponding sensor or sensor system).

In other examples, the AV state change may be associated with one or more cabin changes or cabin state changes of AV 102. Examples of a cabin change of AV 102 includes a door of AV 102 opening, a door of AV 102 closing, changes to the volume of an entertainment system of AV 102, an increase or decrease in brightness of one or more lighting elements or devices within the cabin of AV 102, seat occupancy sensor changes, seatbelt sensor changes or transitions, and use of in-cabin call buttons. Further, executed event engine 103 may generate event data 202 that identifies and characterizes the AV state change associated with the cabin change.

In some instances, executed event engine 103 may obtain sensor data 200 generated by one or more of the multiple sensor systems of AV 102 (e.g., sensor system 104, sensor system 106 and/or sensor system 108), and determine AV state changes associated with a cabin change of AV 102 based on sensor data 200. Further, executed event engine 103 may generate event data 202 that identifies and characterizes the AV state change, such as the door opening or closing. In some instances, event data 202 may include data identifying portions of sensor data 200 that executed event engine 103 utilized to determine the AV state change associated with the cabin change.

By way of example, executed event engine 103 may obtain, from a door sensor of AV 102, sensor data 200. Sensor data 200 may indicate that during a first time interval all the doors of AV 102 are closed and at a time after the first time interval, passenger door on the left side was opened. Based on sensor data 200, executed event engine 103 may determine that the left passenger door was opened at the time after the first time interval. Additionally, executed event engine 103 may generate event data 202 that identifies and characterizes the AV state change associated with the cabin change—the door has been opened. That is, certain events (e.g., the door opening) may be inferred or deduced based on state changes registered at different times. As such, AV 102 may avoid periodically uploading or transmitting AV state information associated with the door sensor. Further, event data 202 may include a timestamp indicating the time the door of AV 102 opened. The timestamp may be based on a portion of sensor data 200 that executed event engine 103 utilized to determine the door of AV 102 opened (e.g., the portion of sensor data 200 may include timestamps of when the portion of sensor data 200 was generated/captured by a corresponding sensor or sensor system).

In another example, executed event engine 103 may obtain, from a door sensor of AV 102, sensor data 200. Sensor data 200 may indicate that during a first time interval the passenger door on the left side of AV 102 is opened and at a time after the first time interval, passenger door on the left side was closed. Based on sensor data 200, executed event engine 103 may determine that the left passenger door was closed at some time after the first time interval. Further, executed event engine 103 may generate event data 202 that identifies and characterizes the AV state change associated with the cabin change—the door has been closed. Further, event data 202 may include a timestamp indicating the time the door of AV 102 closed. The timestamp may be based on a portion of sensor data 200 that executed event engine 103 utilized to determine the door of AV 102 closed (e.g., the portion of sensor data 200 may include timestamps of when the portion of sensor data 200 was generated/captured by a corresponding sensor or sensor system).

In another example, sensor data 200 may include data indicating a light brightness level within the cabin of AV 102. In such example, executed event engine 103 may obtain sensor data 200 during a first time interval that indicates a light brightness level during the first time interval is at a first level. Additionally, executed event engine 103 may obtain additional sensor data 200 at a second time after the first time interval that indicates a light brightness level during has increased to a second level. Based on sensor data 200 received from a first time interval and sensor data 200 received at a second time, executed event engine 103 may determine that the light brightness level within the cabin of AV 102 increased from a first level to a second level at the second time. Executed event engine 103 may generate event data 202 that identifies and characterizes the AV state change associated with the cabin change—the light brightness level within the cabin of AV 102 increased from a first level to a second level. Further, event data 202 may include a timestamp indicating the time the light brightness level within the cabin of AV 102 increased from the first level to a second level. The timestamp may be based on a portion of sensor data 200 that executed event engine 103 utilized to determine the light brightness level within the cabin of AV 102 increased from the first level to a second level (e.g., the portion of sensor data 200 may include timestamps of when the portion of sensor data 200 was generated/captured by a corresponding sensor or sensor system).

In other instances, executed event engine 103 may receive from one or more sensors data from other systems, modules, or stacks of AV 102 that indicate a cabin change of AV 102. For instance, executed event engine 103 may continuously or periodically obtain data from a multimedia system of AV 102. The data may indicate a volume level of the multimedia system during the operation of AV 102. obtain, from a door sensor of AV 102, sensor data 200. Executed event engine 103 may determine a change in the volume level of the multimedia system during the operation of AV 102. Additionally, generate event data 202 that identifies and characterizes the AV state change associated with the cabin change—the increase or decrease in volume of the multimedia system.

By way of example, executed event engine 103 may obtain, from a multimedia system of AV 102 and at a first time, data indicating that during a first time interval the volume level of the multimedia system is a at first level. Additionally, executed event engine 103 may obtain, from the multimedia system of AV 102 and at a second time after the first time, data indicating that the volume level of the multimedia system is increased to a second level. Based on the data received from the multimedia system, executed event engine 103 may determine that the volume level of the multimedia system increased from a first level to a second level at the second time. Executed event engine 103 may generate event data 202 that indicates the multimedia system increased from a first level to a second level. Further, event data 202 may include a timestamp indicating the time the volume of the multimedia system of AV 102 increased from a first level to a second level. The timestamp may be based on a portion of data from the multimedia system that executed event engine 103 utilized to determine the volume of the multimedia system of AV 102 increase from a first level to a second level (e.g., the portion of sensor data 200 may include timestamps of when the data from the multimedia system was generated/captured by the multimedia system).

In various examples, the AV state change may be associated with one or more environmental changes associated with AV 102. In such examples, the environmental changes may be associated with one or more objects that AV 102 encounters (e.g., a pedestrian detected within a proximity distance threshold of AV 102). In some instances, executed event engine 103 of event system 101 may obtain perception data 208 from perception stack 112 and determine AV state changes associated with an environment associated with AV 102 based on perception data 208. As described herein, perception stack 112 may generate perception data 208 based on sensor data 200. Additionally, perception data 208 may identify and classify objects, such as pedestrians, around AV 102. Additionally, perception data 208 may include information characterizing, for each identified object, a corresponding current location, speed, direction, and the like. Moreover, perception data 208 may include information characterizing, for each identified object, the free space around the AV 102 and the distance between AV 102 and each of the objects identified in perception data 208. Based on perception data 208, executed event engine 103 may determine or identify one or more objects that are classified as pedestrians. Further, executed event engine 103 may determine or identify objects that are identified as pedestrians that are within a proximity distance threshold from AV 102. Based on determining the pedestrians as being within the proximity distance threshold from AV 102, executed event engine 103, may determine the pedestrians that are within the proximity distance threshold from AV 102 are too close to AV 102. Further, executed event engine 103 may generate event data 202 that identifies and characterizes the AV state change associated with the environmental change—the one or more identified objects of perception data 208 classified as a pedestrian is too close to AV 102. Further, event data 202 may include a timestamp indicating the time AV 102 detected the one or more identified objects were within a proximity distance threshold to AV 102. The timestamp may be based on a portion of perception data 208 that executed event engine 103 utilized to determine the one or more identified objects were within a proximity distance threshold to AV 102 (e.g., the portion of perception data 208 may include a timestamp for each time perception stack 112 determined a location/position and/or pose of the object identified in the portion of localization data 204).

In some examples, the AV state change may be associated with an emergency, such as a collision or accident with one or more objects in an environment associated with AV 102. In such examples, executed event engine 103 may obtain sensor data 200 and determine or identify AV state changes associated with an emergency. For instance, a portion of sensor data 200 may be generated from an impact sensor indicating an impact has occurred with one or more objects. In such an instance, executed event engine 103 may determine a collision has occurred based on the portion of sensor data indicating an impact has occurred. Further, executed event engine 103 may generate event data 202 identifying and characterizing the AV state change associated with an emergency—the detected/determined collision. In another instance, a portion of sensor data 200 may be generated from one or more airbag sensors indicating a deployment of one or more airbags within the cabin of AV 102. In such an instance, executed event engine 103 may determine one or more airbags of AV 102 were deployed based on the portion of sensor data 200 indicating the deployment of the one or more airbags. Additionally, executed event engine 103 may generate event data 202 identifying and characterizing the AV state change associated with an emergency—the deployment of the one or more airbags. Further, event data 202 may include a timestamp indicating the time the airbag of AV 102 was deployed. The timestamp may be based on a portion of sensor data 200 that executed event engine 103 utilized to determine the airbag deployed (e.g., the portion of sensor data 200 may include a timestamp for when the portion of sensor data 200 was captured/generated by the one or more airbag sensors).

In another instance, another portion of sensor data 200 may be generated by one or more of the multiple sensor systems of AV 102, such as a GPS receiver, speedometer, odometer, etc. Additionally, the sensor data 200 may indicate a speed and/or acceleration of AV 102. Moreover, the sensor data may be in the format of a record that includes multiple entries. Each entry may identify and characterize information generated by one or more of the multiple sensor systems of AV 102 (e.g., a corresponding value), a timestamp indicating a time the information was generated by a corresponding sensor of one of the multiple sensor systems of AV 102, and the type of sensor that generate the information. Based on the record of sensor data 200, executed event engine 103 may determine whether AV 102 decelerated abruptly. Moreover, executed event engine 103 may determine AV 102 may have been in a collision or an accident based on the determination that AV 102 decelerated abruptly. Further, executed event engine 103 may generate event data 202 that includes information identifying and characterizing the AV state change may be associated with an emergency, such as the abrupt deceleration of AV 102 may be due to a collision. Event data 202 may include a timestamp indicating the time AV 102 abruptly decelerated. The timestamp may be based on a portion of sensor data 200 that executed event engine 103 utilized to determine the abrupt deceleration (e.g., the portion of sensor data 200 may include a timestamp for when the portion of sensor data 200 was captured/generated by the one or more airbag sensors).

In some examples, event data 202 may include related data associated with the associated AV state change. In such examples, executed event engine 103 performs example processes as describe herein, to, among other things, determine an AV state change and a time when the AV state change occurred based on data generated by one or more systems, components, modules and/or software stacks (e.g., sensor data 200 generated by one or more of the multiple sensor systems, such as sensor system 104, sensor system 106 and/or sensor system 108). Additionally, executed event engine 103 may utilize the determined time of the occurrence of the AV state change to identify or determine related data of the AV state change. In various instances, executed event engine 103 may perform operations that store, within the one or more tangible non-transitory memories of local computing device 110, such as AV operational database 124, event data 202 and, in some instances, including the related data.

In some instances, the related data may include information identifying and characterizing a location/position and/or a pose of AV 102 at the time the AV state change occurred. For instance, based on localization data 204 and the time when the AV state change occurred, executed event engine 103 may determine portions of localization data 204 that identify and characterize a location/position and/or pose of AV 102 at the time the AV state change occurred. In such an instance, executed event engine 103 may generate the related data that includes information characterizing the location/position and/or pose of AV 102 at the time the AV state change occurred. Further, executed event engine 103 may include the related data within the event data 202.

In other instances, executed event engine 103 the related data may include information about the AV state change at the time the AV state change occurred. Such related data may include information about the AV state change at the time the AV state change occurred. For instance, the related data may include information associated with the data executed event engine 103 utilized to determine the AV stage change.

In instances where the AV state change is associated with a kinematic change of AV 102, event data 202 may include portions of sensor data 200 or localization data 204 executed event engine 103 utilized to determine the AV state change. For instance, executed event engine 103 may utilize localization data 204 formatted as a record, such as a first entry and second entry of the record, to determine AV 102 changed lanes between a time of a timestamp associated with the first entry and a time of a timestamp associated with the second entry. Additionally, executed event engine 103 may generate related data that includes the first entry and the second entry. In such an instance, executed event engine 103 may include in event data 202 the related data along with data identifying and characterizing the AV state change associated with the kinematic change—the lane change.

In instances where the AV state change is associated with a cabin change of AV 102, event data 202 may include portions of sensor data 200 of sensors associated with the cabin of AV 102 or data generated by one or more components associated with the cabin of AV 102. For instance, executed event engine 103 may utilize a portion of sensor data 200 generated by one or more door sensors to determine the left side passenger door of AV 102 is opened and at a time subsequently after a first time interval passenger door on the left side was closed. Additionally, executed event engine 103 may generate related data that includes the portion of sensor data 200 that executed event engine 103 utilized to determine the left side passenger door of AV 102 was opened at the time subsequently after the first time interval. In such an instance, executed event engine 103 may include in event data 202 the related data along with data identifying and characterizing the AV state change associated with the cabin change—the door opening.

In instances where the AV state change is associated with a change in an environment associated with AV 102, event data 202 may include portions data generated by one or more systems, components, modules and/or software stacks of AV 102. Additionally, the portions of data may be associated with the environment. For instance, executed event engine 103 may utilize a portion of perception data 208 to determine one or more objects, such as a pedestrian, is within a proximity distance threshold to AV 102. Additionally, executed event engine 103 may determine the one or more objects are too close to AV 102 based on determining the one or more objects are within the proximity distance threshold to AV 102. Further, executed event engine 103 may generate related data that includes the portion of perception data 208 that executed event engine 103 utilized to determine the one or more objects are too close to AV 102. In such an instance, executed event engine 103 may include in event data 202 the related data along with data identifying and characterizing the AV state change associated with the environment—the one or more objects, such as a pedestrian, being too close to AV 102.

In instances where the AV state change is associated with an emergency, event data 202 may include portions of sensor data 200 that executed event engine 103 utilizes to determine the AV state change associated with the emergency. For instance, executed event engine 103 may utilize a portion of sensor data 200 (e.g., sensor data generated by GPS receiver, speedometer, odometer, etc.) that indicates a speed and/or acceleration of AV 102 to determine AV 102 decelerated abruptly. Based on determining AV 102 decelerated abruptly, executed event engine 103 may determine AV 102 may have been in a collision or an accident based on the determination that AV 102 decelerated abruptly. Additionally, executed event engine 103 may generate related data that includes the portion of sensor data 200 that executed event engine 103 utilized to determine AV 102 decelerated abruptly and AV 102 may have been in a collision, or an accident based on the determination that AV 102 decelerated abruptly. In such an instance, executed event engine 103 may include in event data 202 the related data along with data identifying and characterizing the AV state change associated with the cabin change—the door opening.

In another instance, the related data may include information about the AV state at the time of the AV state change. In such an instance, executed event engine 103 may identify additional data associated with the AV state and the time the AV state change occurred (e.g., perception data 208 generated by perception stack 112, prediction data 210 generated by prediction stack 116, and sensor data 200 generated by one or more sensor systems of AV 102). Examples of the additional data may include portions of sensor data 200 that include one or more images or video of an environment associated with AV 102 at the time the AV state change occurred, perception data 208 of one or more objects around AV 102 at the time the AV state change occurred, and prediction data 210 of the one or more objects identified in the perception data at the time the AV state change occurred.

In various instances, the related data may include information about the AV state change during a time interval leading up to and including the time of the AV state change. In such instances, executed event engine 103 may identify additional data associated with the AV state during a time interval leading up to and including the time of the AV state change (e.g., perception data 208 generated by perception stack 112, prediction data 210 generated by prediction stack 116, and sensor data 200 generated by one or more sensor systems of AV 102). Examples of the additional data may include portions of sensor data 200 that include one or more images or video of an environment associated with AV 102 at the time the AV state change occurred and/or during a time interval leading up to and including the time the AV state change occurred, perception data 208 of one or more objects around AV 102 at the time the AV state change occurred and/or during a time interval leading up to and including the time the AV state change occurred, and prediction data 210 of the one or more objects identified in the perception data at the time the AV state change occurred and/or during a time interval leading up to and including the time the AV state change occurred.

By way of example, executed event engine 103 may obtain sensor data 200 generated by one or more of the multiple sensor systems of AV 102, such as a GPS receiver, speedometer, odometer, etc. Additionally, the sensor data 200 may indicate a speed and/or acceleration of AV 102. Moreover, the sensor data may be in the format of a record that includes multiple entries, such as a first entry, a second entry and a third entry. Each entry may identify and characterize information generated by one or more of the multiple sensor systems of AV 102 (e.g., a corresponding value), a timestamp indicating a time the information was generated by a corresponding sensor of one of the multiple sensor systems of AV 102, and the type of sensor that generate the information. Additionally, the first entry includes a timestamp of a time prior to a time of a timestamp of the second entry and the third entry, and the time of the timestamp of the second entry is before the time of the timestamp of the third entry. Moreover, the first entry indicates AV 102 was traveling 40 miles per hour (mph), the second entry indicates AV 102 was traveling at 40 mph and the third entry indicates AV 102 is traveling at 0 mph. Based on the first entry, second entry and third entry, executed event engine 103 may determine that the AV 102 deceleration at the time of the timestamp of the third entry is abrupt. Further, based on the timestamp of the third entry, executed event may obtain, from one or more sensor systems of AV 102, perception stack 112 and/or prediction stack 116, portions of sensor data 200, perception data 208 and/or prediction data 210 as described herein, respectively. As described herein, the portions of sensor data 200 may include images captured by one or more cameras of sensor system 104 at a time indicated by the timestamp of the third entry or during a time interval lead up to and including the time indicated by the timestamp of the third entry. Additionally, the portions of prediction data 210 and/or perception data 208 that are associated with one or more objects identified in perception data 208 at a time indicated by the timestamp of the third entry or during a time interval lead up to and including the time indicated by the timestamp of the third entry. Moreover, executed event engine 103 may generate related data including the obtained portions of portions of sensor data 200, perception data 208 and/or prediction data 210. Further, executed event engine 103 may include the related data into event data 202 identifying and characterizing the AV state change associated with the emergency (e.g., the abrupt deceleration of AV 102).

In another example and based on one portions of perception data 208, executed event engine 103 may determine or identify objects that are identified as pedestrians that are within a proximity distance threshold from AV 102, as described herein. Based on determining the pedestrians as being within the proximity distance threshold from AV 102, executed event engine 103, may determine the occurrence of a state change of AV 102 associated with the environment at a particular time-detection of pedestrians that are within the proximity distance threshold from AV 102. Additionally, executed event engine 103 may obtain from one or more sensor systems of AV 102 portions of sensor data 200 include images captured by one or more cameras of sensor system 104 at the state change of AV 102 associated with the environment occurred (e.g., the time when the pedestrians were detected to be within a proximity distance threshold from AV 102). Moreover, executed event engine 103 may generate related data including the obtained portions of sensor data 200. Further, executed event engine 103 may include the related data into event data 202 identifying and characterizing the AV state change associated with the environment at the time (e.g., the detection of pedestrians that are within the proximity distance threshold from AV 102).

Referring back to FIG. 2, AV 102 may generate message 212 and provide message 212 to data center 150 based on or in response to determining the AV state changes (e.g., kinematic changes, cabin changes, environmental changes, and emergencies) of AV 102. As such, AV 102 may avoid periodically uploading or transmitting AV state information associated with the movement of AV 102. For example, based on or in response to determining an AV state change, executed event engine 103 may perform operations that generate message 212 and package within one or more portions of message 212, one or more portions of event data 202 and, in some instances, including corresponding portions of related data. Additionally, executed event engine 103 may perform operations that provide message 212, including the portions of event data 202, to data center 150, over a communications network. Examples of the communications network include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. In some instances, the devices and systems operating within AV environment 100 may perform operations that establish and maintain one or more secure channels of communication across the communications network, such as, but not limited to, a transport layer security (TSL) channel, a secure socket layer (SSL) channel, or any other suitable secure communication channel.

As illustrated in FIG. 2, data center 150 may receive message 212, including the portions of event data 202 and, in some instances, corresponding portions of the related data. Additionally, data center 150 may parse message 212 and obtain the portions of event data 202 and corresponding portions of the related data. Further, data center 150 may perform operations that support and manage AV 102 based on the obtained portions of event data 202 and corresponding portions of the related data.

In some examples, data center 150 and any of the systems of data center 150, such diagnostics platform 214 and cloud services platform 216, may perform any of the example processes described herein to, among other things, determine a time an AV state change occurred based on the portions of event data 202 and, in some instances, corresponding portions of related data. For example, data center 150 (or any of the systems of data center 150) may parse the portions of event data 202 to identify a timestamp or determine a time indicating the occurrence of the AV state change identified and characterized in the portions of event data 202. Additionally, data center 150 (or any of the systems of data center 150) may perform any of the example processes described herein to, determine one or more interpolated AV states during a time interval prior to the time of the AV state change. For example, data center 150 may determine the interpolated AV states during the time interval prior to the time of the AV state change, based on the portions of event data 202 and, in some instances, corresponding portions of related data.

In some instances, executed event engine 103 may provide multiple messages, such as message 212, that each include event data, such as event data 202, of the same type of AV state change. Additionally, each message may include event data of an AV state change that occurred at different times. For instance, executed event engine 103 may generate event data 202 of a first lane change at a first time. Additionally, executed event engine 103 may generate and transmit message 212 that includes portions of event data 202 and, in some instances, corresponding portions of related data, to data center 150. Moreover, executed event engine 103 may generate event data 202 of a second lane change at a second time. Further, executed event engine 103 may generate and transmit a second message including the portions of second event data of a second lane change to data enter 150.

As described herein, data center 150 and any of the systems of data center 150 (e.g., diagnostics platform 214 and cloud services platform 216) may perform any of the example processes described herein to, among other things, determine, for each AV state change, a corresponding a time the AV state change occurred based on corresponding portions of event data 202. Additionally, data center 150 (or any of the systems of data center 150) may perform any of the example processes described herein to determine the interpolated AV states during a time interval between the times between two AV state changes. For instance, and following the example above, data center 150 (or any of the systems of data center 150) may determine a first time the first lane change occurred based on corresponding portions of event data, such as event data 202. Additionally, data center 150 (or any of the systems of data center 150) may determine a second time the second lane change occurred based on corresponding portions of event data. Based on the corresponding portions of event data and/or corresponding portions of related data of the first AV state change and the second AV state change, data center 150 (or any of the systems of data center 150) may determine the interpolated AV states during a time interval between the first time and the second time.

As described herein, at least one processor of data center 150 may execute diagnostics platform 214 to identify and determine one or more faults or errors associated with AV 102. In some examples, diagnostics platform 214 may obtain event data 202, and in some instances, corresponding portions of related data. Additionally, diagnostics platform 214 may determine a time an AV state change occurred based on the portions of event data 202 and, in some instances, corresponding portions of related data. Moreover, diagnostics platform 214 may determine the interpolated AV states during a time interval prior to the time of the AV state change. Further, diagnostics platform 214 may perform one or more diagnostics operations to determine and identify one or more faults or errors associated with AV 102 based on the interpolated AV states during at time interval prior to the time of the AV state change of the portions of event data 202.

By way of example, event data 202 may include data identifying and characterizing an AV state change associated with an environment associated with AV 102. Additionally, the AV state change may be associated with a detection or determination that a pedestrian is within a proximity distance threshold from AV 102 and is therefore too close to AV 102. In such example, diagnostics platform 214 may determine a time the AV state change occurred (e.g., when AV 102 determined or detected that the pedestrian was within a proximity distance threshold to AV 102) based on a timestamp associated with the AV state change identified in the portions of event data 202. Additionally, diagnostics platform 214 may determine the interpolated AV states during a time interval prior to the time of the AV state change based on portions of event data 202 and/or corresponding portions of the related data.

For instance, the related data may include portions of localization data 204, portions of sensor data 200 (e.g., a speed of AV 102, one or more images of the environment associated with AV 102, etc.), and portions of perception data 208 and/prediction data 210 associated with the pedestrian is associated with a time interval prior to and including the time the pedestrian was detected or determined to be within a proximity distance threshold. In some instances, the AV state may include the location/position and/or pose of AV 102 during the time interval prior to and including the time of the AV state change. For example, based on the portions of localization data 204 included in the related data, diagnostic platform 214 may determine a position/location and/or pose of AV 102 at the time the pedestrian was detected or determined to be within a proximity distance threshold to AV 102. Moreover, based on the portions of sensor data 200, diagnostic platform 214 may determine a speed of AV 102 at the time the pedestrian was detected or determined to be within a proximity distance threshold to AV 102. Based on the determined speed of AV 102 at the time of the AV state change and the determined location/position and/or pose of AV 102 at the time of the AV state change, diagnostic platform 214 may determine one or more locations/positions and/or pose of AV 102 during the time interval prior to the AV state change.

In other instances, the AV state may include determinations associated with the environment associated with AV 102, such as determinations associated with one or more other objects near or around AV 102 during the time interval prior to and including the time of the AV state change. For example, based on the portions of sensor data 200, perception data 208 and/prediction data 210, diagnostics platform 214 may perform any of the exemplary process described herein to, among other things, determine the context of AV 102 when the pedestrian was within the proximity distance threshold, such as determining what objects were around AV 102 at the time the pedestrian was within the proximity distance threshold, the position/location and/or pose of such objects and corresponding motion characteristics (e.g., speed, and trajectory/future paths). Further, based on the motion characteristics of the objects around AV 102 and the location/position and/or pose of the objects, cloud services platform 216 may determine one or more locations/positions and/or pose of the objects during the time interval prior to the AV state change. In various instances, diagnostics platform 214 may further determine whether the pedestrian was within the proximity distance threshold because the pedestrian was traveling at a speed and path that was unavoidable to AV 102 (e.g., the pedestrian travel a path that was not predicted or traveled a path that was assigned a value indicating it was a low likelihood) based on the interpolated AV states during the time interval prior to the time the pedestrian was detected or determined to be within a proximity distance threshold from AV 102.

In another example, event data 202 may identify and characterize an AV state change associated with a cabin change of AV 102. Additionally, the AV state change may be associated with a triggering of a seat occupancy sensor (e.g., indicating a passenger is on a corresponding seat). For instance, based on a first portion of sensor data 200 generated by the seat occupancy sensor, executed event engine 103 may generate event data 202. The event data 202 may characterize an AV state change associated with indicates the seat occupancy sensor of a seat in passenger portion of the cabin of AV 102 indicating a passenger is on the seat. Executed event engine 103 may generate related data for event data 202 that includes portions of localization data 204, a second portion of sensor data 200 generated by a camera within the cabin that includes one or more images of the cabin, a third portion of sensor data 200 that indicates a speed of AV 102, and a fourth portion of sensor data 200 or other data associated with or related to the seat occupancy sensor. Additionally, the related data may be associated with a time interval prior to or leading up and including the time the seat occupancy sensor triggered. Moreover, diagnostics platform 214 may determine a time the AV state change occurred (e.g., when the seat occupancy sensor triggered) based on the portions of event data 202. Further, diagnostics platform 214 may determine the interpolated AV states during a time interval prior to the time of the AV state change based on portions of event data 202, and/or the corresponding portions of related data.

In some instances, the interpolated AV states may be associated with kinematic states of AV 102. Examines of such interpolated AV states include a speed, position/location and/or pose of AV 102 during the time interval prior to and including the time of the AV state change. For instance, and following the example above, based on the portions of localization data 204 included in the related data, diagnostic platform 214 may determine a position/location and/or pose of AV 102 at the time the seat occupancy sensor triggered. Moreover, based on the third portion of sensor data 200, diagnostic platform 214 may determine a speed of AV 102 at the time the seat occupancy sensor was triggered. Based on the determined speed of AV 102 at the time of the AV state change and the determined location/position and/or pose of AV 102 at the time of the AV state change, diagnostic platform 214 may determine one or more locations/positions and/or pose of AV 102 during the time interval prior to the AV.

In other instances, the interpolated AV states may include the state of the cabin during a time interval prior to the time of the AV state change (e.g., the triggering of the seat sensor). For instance, and following the example above, based on portions of the sensor data 200 generated by one or more cameras within the cabin of AV 102, diagnostics platform 214 may determine whether a passenger is on a seat associated with the seat occupancy during the time interval prior to the triggering of the seat sensor based on one or more images captured by the camera within the cabin during the time interval leading up to the time when the seat sensor triggered. Additionally, based on the one or more images of the cabin included in the second portion of sensor data 200, diagnostics platform 214 may determine whether a passenger is on a seat associated with the seat occupancy at the time of the triggering of the seat sensor. Based on such determinations, diagnostic platform 213 may determine whether a passenger is in the cabin during the time interval prior to the AV state change, where the passenger(s) are located in the cabin during the time interval if the passenger(s) is/are in the cabin during the time interval, and whether a passenger was/is on the seat of the seat occupancy sensor at the time the seat occupancy sensor triggered or during the time interval prior to the time the seat occupancy sensor triggered. Further, diagnostics platform 214 may determine whether the seat occupancy sensor falsely triggered based on determining whether a passenger is on the seat of the seat occupancy sensor at the time the seat occupancy sensor triggered or during the time interval prior to the time the seat occupancy sensor triggered.

In various instances, the interpolated AV states may include the state of the AV 102 system. For instance, and following the example above, diagnostics platform 214 may determine the seat sensor falsely triggered. In such an instance, diagnostics platform 214 may analyze the fourth portion of sensor data 200 or the other data associated with or related to the seat occupancy sensor. Based on the analysis of the fourth portion of sensor data 200 or the other data associated with or related to the seat occupancy sensor, diagnostics platform 214 may determine one or more states of the seat occupancy sensor and/or related systems and components during a time interval prior to and including the time the seat occupancy sensor falsely triggered. Further, based on the determine states of the seat occupancy sensor and/or related systems, diagnostics platform 214 may determine faults or errors of the seat occupancy sensor and/or related systems that may have caused the seat occupancy sensor to falsely trigger.

As illustrated in FIG. 2, at least one processor of data center 150 may execute cloud services platform 216. The cloud services platform 216, when executed, may execute a one or more cloud service that may each manage one or more AVs, such as AV 102, and provide additional AV-related services to the one or more AVs. Examples of the cloud services include a first cloud service associated with remote/roadside assistance services and a second cloud service associated with ride-hailing services. In some examples, cloud services platform 216 may obtain event data 202, and in some instances, corresponding portions of related data. Additionally, cloud services platform 216 may determine a time an AV state change occurred based on the portions of event data 202. Moreover, cloud services platform 216 may determine the interpolated AV states during a time interval prior to the time of the AV state change. Further, cloud services platform 216 may generate cloud input data characterizing and identifying the interpolated AV states. Cloud services platform 216 may provide the cloud input data to a corresponding cloud service. The cloud service may provide corresponding AV-related services to an associated AV, based on the cloud input data.

By way of example, event data 202 may include data identifying and characterizing an AV state change associated with a kinematic change of AV 102. Additionally, the AV state change may be associated with a lane change. Moreover, cloud services platform 216 may determine a time the AV state change occurred (e.g., when AV 102 changed lanes) based on portions of event data 202. Further, cloud services platform 216 may determine the interpolated AV states during a time interval prior to the time of the AV state change based on the portions of event data 202 and corresponding portions of related data. In some instances, the related data may include portions of localization data 204, a first of sensor data 200 indicating a speed of AV 102, a second portion of sensor data 200 including one or more images of the environment associated with AV 102, and portions of perception data 208 and/prediction data 210 associated with one or more objects AV 102 encountered. As described herein, the related data may be associated with a time interval prior to or leading up and including the time of the lane change. Alternatively, the related data may be associated with the time of the lane change.

In some instances, the AV state may include the location/position and/or pose of AV 102 during the time interval prior to and including the time of the AV state change. For example, based on the portions of localization data 204 included in the related data, cloud services platform 216 may determine a position/location and/or pose of AV 102 at the time of the lane change. Moreover, based on the first portion of sensor data 200, cloud services platform 216 may determine a speed of AV 102 at the time of the lane change. Based on the determined speed of AV 102 at the time of the AV state change and the determined location/position and/or pose of AV 102 at the time of the AV state change, cloud services platform 216 may determine one or more locations/positions and/or pose of AV 102 during the time interval prior to the AV state change.

In other instances, the AV state may include determinations associated with the environment associated with AV 102 associated with, such as determinations associated with one or more other objects near or around AV 102 during the time interval prior to and including the time of the AV state change. For example, based on the second portion of sensor data 200, perception data 208 and/prediction data 210, cloud services platform 216 may perform any of the exemplary process described herein to, among other things, determine the context of AV 102 at the time of the lane change, such as determining what objects were around AV 102 at the time of the lane change, the location/position and/or pose of the objects and corresponding motion characteristics (e.g., speed, and trajectory/future paths). Further, based on the motion characteristics of the objects around AV 102 and the location/position and/or pose of the objects, cloud services platform 216 may determine one or more locations/positions and/or pose of the objects during the time interval prior to the AV state change.

In various instances, cloud services platform 216 may further generate cloud input data identifying and characterizing the interpolated AV states (e.g., the one or more locations/positions and/or pose of AV 102 during the time interval prior to the AV state change and/or the one or more locations/positions and/or pose of the objects during the time interval prior to the AV state change). Additionally, cloud services platform 216 may provide cloud input data to a cloud service, such as a cloud service associated with a ride-hail service. The cloud service may monitor AV 102 and provide AV related services to AV 102 based on the cloud input data. For instance, a user may have initiated a ride-service and AV 102 may be instructed to travel to a pick-up location of the user. While AV 102 is traveling to the user, cloud services platform 216 may provide the cloud input data (e.g., the one or more locations/positions and/or pose of AV 102 during the time interval prior to the AV state change and/or the one or more locations/positions and/or pose of the objects during the time interval prior to the AV state change) to a cloud service associated with a ride-hail service. The cloud service may provide data that establishes and adjusts a route AV 102 is to take to travel to the pick-up location of the user.

In another example, event data 202 may include data identifying and characterizing an AV state change associated with an emergency. In such an example, the AV state change may be associated with a collision. Additionally, cloud services platform 216 may determine a time the AV state change occurred (e.g., when the detected collision of AV 102 occurred) based on the portions of event data 202.

Moreover, cloud services platform 216 may determine the AV state at the time of the AV state change based on the portions of event data 202 and/or corresponding portions of related data. As described herein, the related data may include portions of localization data 204 indicating a position/location and/or pose of AV 102 at the AV state change (e.g., the collision), a first portion of sensor data 200 indicating a current speed of AV 102 at the time the AV state change occurred, a second portion of sensor data 200 including one or more images of the environment associated with AV 102 at the time the AV state change occurred, and portions of perception data 208 and/prediction data 210 associated with one or more objects around AV 102 at the time the AV state change occurred. In some instances, the AV state may include determinations associated with the environment associated with AV 102, such as determinations associated with one or more other objects near or around AV 102 at the time of the AV state change (e.g., the collision). For instance, based on the second portion of sensor data 200, perception data 208 and/prediction data 210, cloud services platform 216 may perform any of the exemplary process described herein to, among other things, determine the context of AV 102 at the time of the collision, such as determining what objects were around AV 102 at the time of the collision, the location/position and/or pose of the objects and corresponding motion characteristics (e.g., speed, and trajectory/future paths). Additionally, or alternatively, the AV state may include the location/position and/or pose of AV 102 at the time of the AV state change (e.g., the collision). For instance, based on the portions of localization data 204 included in the related data, cloud services platform 216 may determine a position/location and/or pose of AV 102 at the time of the collision.

Further, cloud services platform 216 may further generate cloud input data identifying and characterizing the AV state at the time of the AV state change, such as a collision (e.g., the one or more locations/position and/or pose of AV 102 at the time of the AV state change). Additionally, cloud services platform 216 may provide the cloud input data to a cloud service, such as a cloud service associated with emergency services. The cloud service may provide AV related services to the AV based on the cloud input data. For instance, the cloud service may route emergency services to the location of AV 102 and may provide information about the collision of AV 102 to the emergency services, such as the one or more images or other derived information of the surrounding area.

In some instances, the cloud service may request, via cloud services platform 216, additional data or information about the AV state from AV 102 at the time of the AV state change (e.g., a collision). For instance, the cloud service may transmit a request to cloud services platform 216 to obtain, via cloud services platform 216, a live video feed from one or more cameras of AV 102. Additionally, the cloud services may route the live video feed to the emergency services.

In other instances, the cloud service may request, from cloud services platform 216, additional data or information associated with the interpolated AV states during a time interval prior to the time of the AV state change occurred. In such instances, cloud services platform 216 may request, from AV 102, additional portions of related data associated with event data 202. As described herein, the additional portions of related data may include additional portions of localization data 204, additional portions of sensor data 200 indicating a speed of AV 102, and/or one or more images of the environment associated with AV 102, and additional portions of perception data 208 and/prediction data 210 associated with one or more objects AV 102 encountered. As described herein, the related data may be associated with a time interval prior to and including the time the AV state changed occurred (e.g., the collision). Additionally, cloud services platform 216 may receive the additional related data from AV 102 and determine the interpolated AV states during the time interval prior to the time of the AV state change occurred.

In various instances, and based on the additional related data, the interpolated AV states may include determinations associated with the environment associated with AV 102, such as determinations associated with one or more other objects near or around AV 102 during the time interval prior to the AV state change. For instance, based on the additional portions of sensor data 200, perception data 208 and/prediction data 210, cloud services platform 216 may perform any of the exemplary process described herein to, among other things, determine the context of AV 102 during a time interval prior to the time of the collision, such as determining one or more locations/positions and/or poses of one or more objects AV 102 encountered during the time interval prior to the time of the collision. Additionally, or alternatively, AV state may include the location/position and/or pose of AV 102 during the time interval prior to the time of the AV state change. For instance, based on the additional portions of sensor data 200, such as portions indicating the speed of AV 102 prior to the collision, and the additional portions of localization data 204, cloud services platform 216 may determine the speed and one or more positions/locations and/or poses of AV 102 during the time interval prior to the collision.

Further, cloud services platform 216 may further generate additional cloud input data identifying and characterizing the interpolated AV states during the time interval prior to the AV state change, such as a collision (e.g., the one or more locations/position and/or pose of AV 102 during the time interval prior to the AV state change). Additionally, cloud services platform 216 may provide the additional cloud input data to the cloud service, such as a cloud service associated with emergency services. The cloud service may provide AV related services to the AV based on the additional cloud input data. For instance, the cloud service may provide the additional information included in the additional cloud input data to the emergency services, such as the one or more images or other derived information of the surrounding areas associated with AV 102 during the time interval prior to the collision.

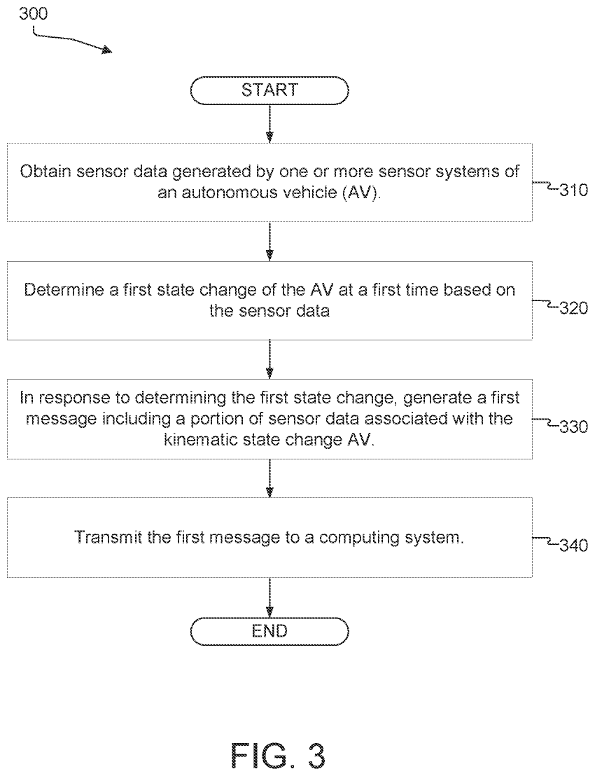

FIG. 3 is a flow chart of an example process 300 for determining one or more AV state changes. In some instances, one or more components of AV environment 100 may perform all or a portion of the steps of example process 300, which include but are not limited to obtaining sensor data by one or more sensor systems of an autonomous vehicles (AVs), determining a first AV state change at a first time based on the sensor data, in response to determining the first AV state change, generating a first message including a portion of sensor data associated with the first state change, and transmitting the first message to a computing system.

Referring to FIG. 3, executed event engine 103 may obtain sensor data by one or more sensor systems of an autonomous vehicles (AV) (e.g., step 310). Additionally, executed event engine 103 may determine a first AV state change of the AV at a first time based on the sensor data (e.g., step 320). As described herein, the AV state change may be associated with a kinematic change of a corresponding AV, a cabin change of a corresponding AV, the environment associated with the AV, and an emergency involving the corresponding AV. Other examples of AV state changes may be associated with other components, systems or subsystems the AV, such as, but not limited to, sensor state changes, steering angle changes, brake pressure changes, and brake sensor state changes.

By way of example, the first AV state change may be associated with a kinematic change of an autonomous vehicle, such as AV 102. Examples of a kinematic change of AV 102 includes lane changes, odometry changes (e.g., acceleration/deceleration), and pose/orientation/heading changes. Additionally, executed event engine 103 may generate event data 202 that identifies the AV state change associated with the kinematic change of AV 102. Additionally, executed event engine 103 may obtain sensor data 200 generated by one or more of the multiple sensor systems of AV 102 (e.g., sensor system 104, sensor system 106 and/or sensor system 108), and determine the AV state changes associated with a kinematic change of AV 102 based on sensor data 200. Further, the AV state changes may be associated with AV 102 accelerating or decelerating. For instance, executed event engine 103 may obtain sensor data 200 generated by one or more of the multiple sensor systems of AV 102 (e.g., GPS receiver, speedometer, odometer, etc.). Additionally, the sensor data 200 may be in the format of a record that includes multiple entries. Each entry may identify and characterize information generated by one or more of the multiple sensor systems of AV 102 (e.g., a corresponding value), a timestamp indicating a time the information was generated by a corresponding sensor of one of the multiple sensor systems of AV 102, and the type of sensor that generate the information. Based on the record of sensor data 200, executed event engine 103 may determine whether AV 102 accelerated and the corresponding time of the acceleration or whether AV 102 decelerated and the corresponding time of the deceleration. Further, based on such determinations, executed event engine 103 may generate event data 202 that identifies and characterizes the AV state change associated with the kinematic change—the acceleration or deceleration of AV 102.

Referring to FIG. 3, executed event engine 103 may, in response to determining the first AV state change, generate a first message including a portion of sensor data associated with the first state change (e.g., step 330). Additionally, executed event engine 103 may transmit the first message to a computing system (e.g., step 340). In some examples, executed event engine 103 may perform operations that generate message 212 and package within one or more portions of message 212, one or more portions of event data 202 and, in some instances, including corresponding portions of related data. Additionally, executed event engine 103 may perform operations that provide message 212, including the portions of event data 202, to data center 150, over a communications network.

In some examples, data center 150 and any of the systems of data center 150, such as map management platform 162, diagnostics platform 214 and cloud services platform 216, may perform any of the example processes described herein to, among other things, determine a time an AV state change occurred based on the portions of event data 202. For example, data center 150 (or any of the systems of data center 150) may parse the portions of event data 202 to identify a timestamp or determine a time indicating the occurrence of the AV state change identified and characterized in the portions of event data 202. Additionally, data center 150 (or any of the systems of data center 150) may perform any of the example processes described herein to, determine one or more interpolated AV states during a time interval prior to the time of the AV state change. For example, data center 150 may determine the interpolated AV states during the time interval prior to the time of the AV state change of the portions of event data 202, based on the portions of event data 202 and/or the corresponding portions of related data.

As described herein, in some instances, data center 150 (or any of the systems of data center 150) may receive multiple messages including event data and, in some instances, corresponding related data. Each of the multiple messages may include event data of an AV state change that occurred at different times and are of the same type of AV state change (e.g., an AV state change associated with a cabin change). In such instances, data center 150 (or any of the systems of data center 150) may determine, for each message, a time of an AV state change based on the corresponding event data. Further, data center 150 (or any of the systems of data center 150) may perform any of the example processes described herein to, determine the interpolated AV states during a time interval between the determined times of each of the AV state changes.

By way of example, for a first message, data center 150 (or any of the systems of data center 150) may determine a first time a seat occupancy sensor was triggered based on corresponding portions of event data included in the first message. Additionally, for a second message, data center 150 (or any of the systems of data center 150) may determine a second time the seat occupancy sensor was triggered based on corresponding portions of event data included in the second message. Based on the corresponding portions of event data and/or corresponding portions of related data of the first time the seat occupancy sensor data triggered and the second time the seat occupancy sensor data triggered, data center 150 (or any of the systems of data center 150) may determine the interpolated AV states during a time interval between the first time and the second time. For instance, a state of the seat occupancy sensor at one or more points in time between the first time and the second time.

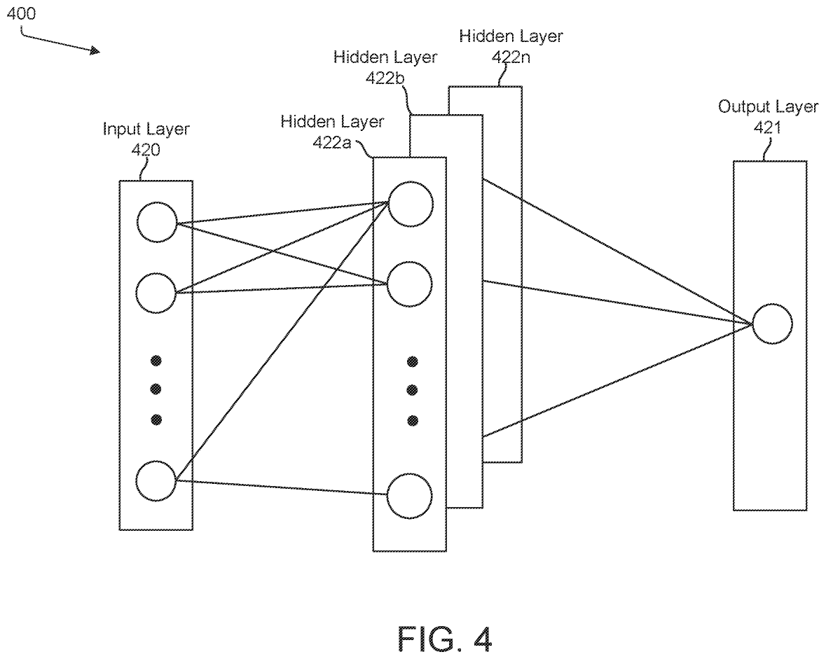

In FIG. 4, the disclosure now turns to a further discussion of models that can be used through the environments and techniques described herein. FIG. 4 is an example of a deep learning neural network 400 that can be used to implement all or a portion of the systems and techniques described herein (e.g., neural network 400 can be used to implement a perception module (or perception system) as discussed above). An input layer 420 can be configured to receive sensor data and/or data relating to an environment surrounding an AV. Neural network 400 includes multiple hidden layers 422a, 422b, through 422n. The hidden layers 422a, 422b, through 422n include “n” number of hidden layers, where “n” is an integer greater than or equal to one. The number of hidden layers can be made to include as many layers as needed for the given application. Neural network 400 further includes an output layer 421 that provides an output resulting from the processing performed by the hidden layers 422a, 422b, through 422n.

Neural network 400 is a multi-layer neural network of interconnected nodes. Each node can represent a piece of information. Information associated with the nodes is shared among the different layers and each layer retains information as information is processed. In some cases, the neural network 400 can include a feed-forward network, in which case there are no feedback connections where outputs of the network are fed back into itself. In some cases, the neural network 400 can include a recurrent neural network, which can have loops that allow information to be carried across nodes while reading in input.

Information can be exchanged between nodes through node-to-node interconnections between the various layers. Nodes of the input layer 420 can activate a set of nodes in the first hidden layer 422a. For example, as shown, each of the input nodes of the input layer 420 is connected to each of the nodes of the first hidden layer 422a. The nodes of the first hidden layer 422a can transform the information of each input node by applying activation functions to the input node information. The information derived from the transformation can then be passed to and can activate the nodes of the next hidden layer 422b, which can perform their own designated functions. Example functions include convolutional, up-sampling, data transformation, and/or any other suitable functions. The output of the hidden layer 422b can then activate nodes of the next hidden layer, and so on. The output of the last hidden layer 422n can activate one or more nodes of the output layer 421, at which an output is provided. In some cases, while nodes in the neural network 400 are shown as having multiple output lines, a node can have a single output and all lines shown as being output from a node represent the same output value.

In some cases, each node or interconnection between nodes can have a weight that is a set of parameters derived from the training of the neural network 400. Once the neural network 400 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 400 to be adaptive to inputs and able to learn as more and more data is processed.

The neural network 400 is pre-trained to process the features from the data in the input layer 420 using the different hidden layers 422a, 422b, through 422n in order to provide the output through the output layer 421.

In some cases, the neural network 400 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 400 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½(target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 400 can perform a backward pass by determining which inputs (weights) most contributed to the loss of the network and can adjust the weights so that the loss decreases and is eventually minimized.

The neural network 400 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 400 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a data center, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L#), Resistive RAM (RRAM/ReRAM), Phase Change Memory (PCM), Spin Transfer Torque RAM (STT-RAM), another memory chip or cartridge, and/or a combination thereof.

Storage device 530 can include software services, servers, services, etc., that when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:

Aspect 1: A computing system comprising: a communications interface; a memory storing instructions; and at least one processor coupled to the communications interface and to the memory, the at least one processor being configured to execute the instructions to: obtain sensor data generated by one or more sensor systems of an autonomous vehicle (AV); determine a first AV state change of the AV at a first time based on the sensor data, the first AV state change being associated with a kinematic change of the AV; in response to determining the first AV state change, generate a first message including a portion of the sensor data associated with the kinematic change; and transmit, over one or more communication networks and to a data center, the first message, the first message causing the data center to determine one or more interpolated AV states of the AV during a time interval before the first time based on the first message.

Aspect 2: The computing system of Aspect 1, wherein the at least one processor is further configured to: determine a second AV state change of the AV at a second time after the first time based on the sensor data, the second AV state change being associated with the kinematic change of the AV; in response to determining the second AV state change, generate a second message including a second portion of the sensor data associated with the kinematic change; and transmit, over one or more communication networks and to the data center, the second message.

Aspect 3: The computing system of Aspect 2, wherein the data center determines the one or more interpolated AV states of the AV during a time interval between the first time and the second time.

Aspect 4: The computing system of Aspect 3, wherein a first interpolated AV state of the one or more interpolated AV states is associated with a kinematic state of the AV.

Aspect 5: The computing system of Aspect 1-4, wherein the first AV state change of the AV is associated with an environment associated with the AV.

Aspect 6: The computing system of Aspect 1-5, wherein the first AV state change is further associated with an emergency event, wherein the kinematic change indicates an emergency event.

Aspect 7: The computing system of Aspect 1-6, wherein the data center is further configured to provide the portion of the sensor data to one or more cloud services, wherein the one or more cloud services are associated with the first AV state change.

Aspect 8: A computer-implemented method comprising: obtaining sensor data generated by one or more sensor systems of an autonomous vehicle (AV); determining a first AV state change of the AV at a first time based on the sensor data, the first AV state change being associated with a kinematic change of the AV; in response to determining the first AV state change, generating a first message including a portion of sensor data associated with the kinematic change; and transmitting, over one or more communication networks and to a data center, the first message, the first message causing the data center to determine one or more interpolated AV states of the AV during a time interval before the first time based on the first message.

Aspect 9: The computer-implemented method of Aspect 8, further comprising: determining a second AV state change of the AV at a second time after the first time based on the sensor data, the second AV state change being associated with the kinematic change of the AV; in response to determining the second AV state change, generating a second message including a second portion of the sensor data associated with the kinematic change of the AV; and transmitting, over one or more communication networks and to the data center, the second message.

Aspect 10: The computer-implemented method of Aspect 9, wherein the data center determines the one or more interpolated AV states of the AV during a time interval between the first time and the second time.

Aspect 11. The computer-implemented method of Aspect 10, wherein a first interpolated AV state of the one or more interpolated AV states is associated with a kinematic state of the AV.

Aspect 12: The computer-implemented method of Aspect 8 to 11, wherein the first AV state change of the AV is associated with an environment associated with the AV.

Aspect 13: The computer-implemented method of Aspect 8 to 12, wherein the first AV state change is further associated with an emergency event, wherein the kinematic change indicates an emergency event.

Aspect 14: The computer-implemented method of Aspect 8 to 13, wherein the first message further causes the data center to provide the portion of the sensor data to one or more cloud services, wherein the one or more cloud services are associated with the first AV state change.

Aspect 15. A tangible, non-transitory computer readable medium storing instructions that, when executed by at least one processor, cause the at least one processor to perform operations comprising: obtaining sensor data generated by one or more sensor systems of an autonomous vehicle (AV); determining a first AV state change of the AV at a first time based on the sensor data, the first AV state change being associated with a kinematic change of the AV; in response to determining the first AV state change, generating a first message including a portion of sensor data associated with the kinematic change; and transmitting, over one or more communication networks and to a data center, the first message, the first message causing the data center to determine one or more interpolated AV states of the AV during a time interval before the first time based on the first message.

Aspect 16: The tangible, non-transitory computer readable medium of Aspect 15, and wherein the at least one processor further performs operations comprising: determining a second AV state change of the AV at a second time after the first time based on the sensor data, the second AV state change being associated with the kinematic change of the AV; in response to determining the second AV state change, generating a second message including a second portion of the sensor data associated with the kinematic change; and transmitting, over one or more communication networks and to the data center, the second message.

Aspect 17: The tangible, non-transitory computer readable medium of Aspect 16, wherein the data center determines the one or more interpolated AV states of the AV during a time interval between the first time and the second time.

Aspect 18. The tangible, non-transitory computer readable medium of Aspect 17, wherein a first interpolated AV state of the one or more interpolated AV states is associated with a kinematic state of the AV.

Aspect 19. The tangible, non-transitory computer readable medium of Aspect 15 to 18, wherein the first AV state change of the AV is associated with an environment associated with the AV.

Aspect 20. The tangible, non-transitory computer readable medium of Aspect 15 to 19, wherein the first AV state change is further associated with an emergency event, wherein the kinematic change indicates an emergency event.

Aspect 21: The tangible, non-transitory computer readable medium of Aspect 15 to 20, wherein the data center is further configured to provide the portion of the sensor data to one or more cloud services, wherein the one or more cloud services are associated with the first AV state change.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of”′ a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A computing system comprising:
a communications interface;
a memory storing instructions; and
at least one processor coupled to the communications interface and to the memory, the at least one processor being configured to execute the instructions to:
obtain sensor data generated by one or more sensor systems of an autonomous vehicle (AV);
determine a first AV state change of the AV at a first time based on the sensor data, the first AV state change being associated with a kinematic change of the AV;
in response to determining the first AV state change, generate a first message including a portion of the sensor data associated with the kinematic change; and
transmit, over one or more communication networks and to a data center, the first message, the first message causing the data center to determine one or more interpolated AV states of the AV during a time interval before the first time based on the first message.

2. The computing system of claim 1, wherein the at least one processor is further configured to:
determine a second AV state change of the AV at a second time after the first time based on the sensor data, the second AV state change being associated with the kinematic change of the AV;
in response to determining the second AV state change, generate a second message including a second portion of the sensor data associated with the kinematic change; and
transmit, over one or more communication networks and to the data center, the second message.

3. The computing system of claim 2, wherein the data center determines the one or more interpolated AV states of the AV during a time interval between the first time and the second time.

4. The computing system of claim 3, wherein a first interpolated AV state of the one or more interpolated AV states is associated with a kinematic state of the AV.

5. The computing system of claim 1, wherein the first AV state change of the AV is associated with an environment associated with the AV.

6. The computing system of claim 1, wherein the first AV state change is further associated with an emergency event, wherein the kinematic change indicates an emergency event.

7. The computing system of claim 1, wherein the data center is further configured to provide the portion of the sensor data to one or more cloud services, wherein the one or more cloud services are associated with the first AV state change.

8. A computer-implemented method comprising:
obtaining sensor data generated by one or more sensor systems of an autonomous vehicle (AV);
determining a first AV state change of the AV at a first time based on the sensor data, the first AV state change being associated with a kinematic change of the AV;
in response to determining the first AV state change, generating a first message including a portion of sensor data associated with the kinematic change; and
transmitting, over one or more communication networks and to a data center, the first message, the first message causing the data center to determine one or more interpolated AV states of the AV during a time interval before the first time based on the first message.

9. The computer-implemented method of claim 8, further comprising:
determining a second AV state change of the AV at a second time after the first time based on the sensor data, the second AV state change being associated with the kinematic change of the AV;
in response to determining the second AV state change, generating a second message including a second portion of the sensor data associated with the kinematic change of the AV; and
transmitting, over one or more communication networks and to the data center, the second message.

10. The computer-implemented method of claim 9, wherein the data center determines the one or more interpolated AV states of the AV during a time interval between the first time and the second time.

11. The computer-implemented method of claim 10, wherein a first interpolated AV state of the one or more interpolated AV states is associated with a kinematic state of the AV.

12. The computer-implemented method of claim 8, wherein the first AV state change of the AV is associated with an environment associated with the AV.

13. The computer-implemented method of claim 8, wherein the first AV state change is further associated with an emergency event, wherein the kinematic change indicates an emergency event.

14. The computer-implemented method of claim 8, wherein the first message further causes the data center to provide the portion of the sensor data to one or more cloud services, wherein the one or more cloud services are associated with the first AV state change.

15. A tangible, non-transitory computer readable medium storing instructions that, when executed by at least one processor, cause the at least one processor to perform operations comprising:
obtaining sensor data generated by one or more sensor systems of an autonomous vehicle (AV);
determining a first AV state change of the AV at a first time based on the sensor data, the first AV state change being associated with a kinematic change of the AV;
in response to determining the first AV state change, generating a first message including a portion of sensor data associated with the kinematic change; and
transmitting, over one or more communication networks and to a data center, the first message, the first message causing the data center to determine one or more interpolated AV states of the AV during a time interval before the first time based on the first message.

16. The tangible, non-transitory computer readable medium of claim 15, wherein the at least one processor further performs operations comprising:
determining a second AV state change of the AV at a second time after the first time based on the sensor data, the second AV state change being associated with the kinematic change of the AV;
in response to determining the second AV state change, generating a second message including a second portion of the sensor data associated with the kinematic change; and
transmitting, over one or more communication networks and to the data center, the second message.

17. The tangible, non-transitory computer readable medium of claim 16, wherein the data center determines the one or more interpolated AV states of the AV during a time interval between the first time and the second time.

18. The tangible, non-transitory computer readable medium of claim 17, wherein a first interpolated AV state of the one or more interpolated AV states is associated with a kinematic state of the AV.

19. The tangible, non-transitory computer readable medium of claim 15, wherein the first AV state change of the AV is associated with an environment associated with the AV.

20. The tangible, non-transitory computer readable medium of claim 15, wherein the first AV state change is further associated with an emergency event, wherein the kinematic change indicates an emergency event.
